(19) United States
(12) Patent Application Publication
(10) Pub. No.: US 2012/0023145 A1
(43) Pub. Date: Jan. 26, 2012

(54) POLICY-BASED COMPUTER FILE MANAGEMENT BASED ON CONTENT-BASED ANALYTICS

(75) Inventors: Karen W. Brannon, San Jose, CA (US); Sangeeta T. Doraiswamy, San Jose, CA (US)

(73) Assignee: INTERNATIONAL BUSINESS MACHINES CORPORATION, Armonk, NY (US)

(21) Appl. No.: 12/842,780

(22) Filed: Jul. 23, 2010

(51) Int. Cl. G06F 17/30

(52) U.S. Cl. 707/822; 707/E17.01

(57) ABSTRACT

Embodiments of this disclosure managing storage of files, stored in a computer storage system having policy-based file storage management, using information derived from content of the files. Embodiments execute content analytics logic module(s) on a primary file stored in a base storage system, creating one or more Features derived from the primary file content. Based on the Feature(s), embodiments automatically determine an electronic storage policy for the primary file and, in certain embodiments, also for the Feature(s). The Features, and accordingly the storage policy, can be updated particularly readily in exemplary embodiments having pluggable content analytics logic modules. This may be occur in light of, for example, new content analytics algorithms (e.g., new image analysis algorithms), new external factors (e.g., new rules governing certain content), and/or new storage equipment (e.g., new storage farms for which it may be more useful or cost effective to store certain types of data).

### FIELD

Embodiments of this invention relate to storage systems and, in particular, to policy-based computer file life-cycle management based on content-based analytics and, in particular, to managing storage of files stored in a policy-based storage system, such as a multimodal file repository, using information derived from content of the files, and generating new Features using information derived from content of the files.

### BACKGROUND

Increasing quantities of digital data are being stored, retrieved, and organized in various manners, formats, and media. Computer storage system repositories store data. Data from various modalities such as text, audio, video, etc. may be stored in base storage systems and require different storage management characteristics according to modality and content. It can be particularly challenging to manage multimodal files in a manner that complies with policies, rules, and/or regulations governing the content, data, and/or file, such as policies, rules, and/or regulations relating to proper storage of medical files or financial data, for example.

### BRIEF SUMMARY

Embodiments of the invention disclose a method of managing storage of electronic files using information derived from content of the electronic files, the electronic files being stored in a computer storage system having policy-based electronic file storage management, the method including executing at least one content analytics logic module on a primary file stored in a base storage system to create one or more Features derived from content of the primary file, wherein the primary file is stored in the base storage system by an external system coupled to the base storage system; and automatically determining an electronic storage policy for the primary file based on the one or more Features.

Embodiments of the invention also disclose a system including a base storage system coupled to an external system, the base storage system to store a plurality of primary files of differing modalities, wherein one of the plurality of primary files is a primary file received from the external system, and wherein the base storage system is configured to provide policy-based file management; and a content analytics platform coupled to the base storage system, the content analytics platform including a content analytics logic module plugged into the content analytics platform and configured to create one or more Features derived from content of the primary file received from the external system; and an Feature manager logic module coupled to the plugged-in content analytics logic module and configured to select an electronic storage policy for the primary file based on the one or more Features and to link the one or more Features to the primary file such that a storage policy for the primary file applies to the one or more Features.

Embodiments of the invention further disclose a computer program product for policy-based computer file life-cycle management based on content-based analytics, the computer program product including a computer usable medium having computer usable program code embodied therewith, the computer usable program code including computer usable program code configured to execute at least one content analytics logic module on a primary file stored in a base storage system creating one or more Features derived from content of the primary file, wherein the primary file is stored in the base storage system by an external system coupled to the base storage system; and computer usable program code configured to automatically determine an electronic storage policy for the primary file based on the one or more Features. The computer usable program code may further include computer usable program code configured to link the primary file to at least one of the one or more Features such that a storage retention policy for the primary file that triggers automatic deletion of the primary file also triggers automatic deletion of the at least one of the one or more Features after expiration of an audit-based retention period.

Other aspects and advantages of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

Embodiments of the invention are described by way of example with reference to the accompanying drawings wherein

FIG. 1 is an illustration of a system in accordance with an embodiment of the invention;

FIG. 2 is another illustration of a system in accordance with an embodiment of the invention;

FIG. 3 is another illustration of a system in accordance with an embodiment of the invention;

FIG. 4 is an illustration of a method in accordance with embodiments of the invention;

FIG. 5 is a high level block diagram showing an information processing system useful for implementing embodiments of the invention; and

FIG. 6 represents an exemplary distributed data processing system in which aspects of the illustrative embodiments may be implemented.

### DETAILED DESCRIPTION

A policy-based storage management system applies a policy-based storage management framework. A policy-based storage management framework specifies how data having certain characteristics are associated with different pools of storage space that will store such data. A policy-based storage management framework also specifies how the data will be managed throughout its lifecycle. A system's policies and schedules can reduce an administrator's workload while helping to ensure that the data is being managed/stored/protected in the appropriate manner.

Multimodal data, including but not limited to audio and visual recordings, transcripts, text and annotations/comments about the text, are being created at an unprecedented rate. Multimodal file repositories store files of differing modalities. These multimodal file repositories often use large amounts of computer storage. Data of differing modalities in a multimodal file repository may have related content. In certain situations, it may be desirable to manage the storage of these content related data differently (e.g., for cost and/or energy efficiency). In other situations, it may be desirable or even legally required to handle, at least certain aspects of, storing these content related data in a similar manner.

Storage systems that enable policy-based storage management of large multimodal file repositories are becoming available, e.g., the IBM Information Archive. Such systems may enable management of file retention, immutability, Hierarchical Storage Management (HSM), etc, all based on storage policies. HSM is a data storage technique that automatically moves data between high-cost (per byte stored) storage media (e.g., high-speed storage devices such as hard disk drive arrays or solid state drives) and low-cost storage media (e.g., slower devices such as optical discs and magnetic tape drives or slower disk drives). HSM is based on primary file metadata, e.g., the size of a primary file. In comparison, exemplary embodiments of this invention are based on metadata derived from analytics of a primary file's content and/or based on a file derived from analytics of the primary file's content.

More generally, embodiments of this invention relate to managing storage of electronic files stored in a computer storage system having a policy-based electronic file storage management using information derived from content of the electronic files and generating new Features using information derived from content of the files. In use, embodiments of the invention apply content analytics to files in a repository to extract actionable Features. For example, content analytics may be applied to a file stored in a multimodal file repository to create a Feature derived from content of the file. The multimodal file repository may be stored in a single base system having a plurality of repositories. Such a single base system may aid in the integration of data from multiple disparate systems. In one embodiment, the base system has a separate repository for each knowledge domain. In one exemplary embodiment, different types of Features are created using one content analytics logic modules. In another embodiment, multiple content analytics logic module are used (e.g., one for each type of Feature, or one for certain types of Features and another for other types of Features). In an exemplary embodiment, the content analytics logic modules are ‘pluggable’. Pluggable content analytics logic modules allow embodiments of the invention to be flexible and specialized for certain applications as appropriate, e.g., for certain industries or certain domains.

As used herein, a primary file is file stored in a base storage system by an external system coupled to the base storage system. For example, a primary file may be an image of a brain taken by a medical imaging machine at a medical facility, and then stored in a secured computer storage system. Medical images from a sleep study may be stored in the computer storage system, for example. In one embodiment, content analytics are applied to the images to extract study results as one or more Features.

As used herein, a Feature is information in any format that is derived from content of a primary file based on application or execution of content analytics on the primary file content. A Feature may be, for example, a derived file, such as a close-up of a particular section of the brain image in the example above. In embodiments of the invention, a content analytics logic module creates the Feature. For example, a content analytics logic module may include an image analysis tool that determines which section of the image in the example above is particularly relevant for extracting and creating the derived file. In certain applications, a derived file may be a thumbnail of the primary file, a video clip (e.g., when the primary file is a video), a summary document, etc. In some instances, the derived file may be smaller in byte size than the primary file, e.g., when a derived file is a video clip of a larger video or a summary of a larger document. In other instances, the derived file may be larger in byte size than the primary file. This may occur, for example, when the derived file is in one file format (e.g., .wav) and the primary file is in another format (e.g., .mp3).

A Feature may also be metadata, e.g., one or more name/value pairs. For example, the same or a different image analysis tool or content analytics logic module as described above may determine that the image shows evidence a certain type of brain activity. Metadata may then be created as a Feature to indicate that that the image relates to that particular type of brain activity.

In one embodiment, based on the Feature(s), a certain storage policy is applied to the primary file. For example, a policy may be applied that causes the system automatically to store the primary image in a near-line storage media if the metadata indicates brain activity of interest in the sleep study (e.g., activity during REM sleep), and a less-expensive storage media if the metadata indicates other types of brain activity (e.g., activity during delta sleep). Determining a storage policy for primary files based on Features derived from the primary files' content using content analytics enables smart management of the primary files. The Features can aid in determining what type of storage media is used to store the primary file (e.g., tape or hard drive), where the primary file is stored, for how long the primary file should be retained, what security measures must control access to the file, etc. The Features used to determine the storage policy can be updated, and particularly readily in embodiments in which the content analytics logic modules are pluggable. Changes to the storage policy may be desirable in light of, for example, new content analytics algorithms (e.g., better image analysis algorithms), new determinative external factors (e.g., new laws or rules governing certain types of content), new storage equipment (e.g., additional storage farms, or new types of storage farms for which it may be more useful or cost effective to store certain types of data), etc.

In certain embodiments, a storage policy is also automatically assigned to one or more of the Features. This storage policy may be the same as that of the primary file. For example, a storage policy may be automatically assigned to a derived file such as a close-up of the brain image. The policy for the derived file and the policy for the primary file may both instruct the storage system to store the close-up image and the original image, respectively, in the near-line storage media. The storage policy may differ in some, or all, instructions. For example, the policy for the derived file may instruct the system to store the close-up in an online storage while the policy for the primary file may instruct the system to store the original image in the near-line storage media. In such embodiments, the storage policies enable the Feature to be readily accessible. This may be useful, for example, if users are expected to access the Feature (e.g., the close up images) more often. In some embodiments, the Features are also indexed to allow for easy searching of the Features or primary files. Features also can be derived from content of files stored in the storage system independent of modality. Accordingly, embodiments of this invention are particularly useful for multimodal file repositories. Thus, for certain embodiments of the invention, storage policies based on content of the primary files can be automatically assigned for derived files as well as for primary files, and these storage policies can be identical or differ depending on the embodiment. Linking the primary files to the Features derived from the primary files enables smart management of the Features. For example, critical storage policies rules, such absolute retention periods for files relating to certain content (e.g., medical data of a specific individual), can be readily satisfied regardless of modality, storage location, or other storage characteristics. For instance, in the example above, if the original brain image must be deleted ten years from its creation, linking the primary file to the derived files (here, the close-up) can enable automatic deletion of the derived file at the same time as deletion of the primary file, regardless of when the derived file was created.

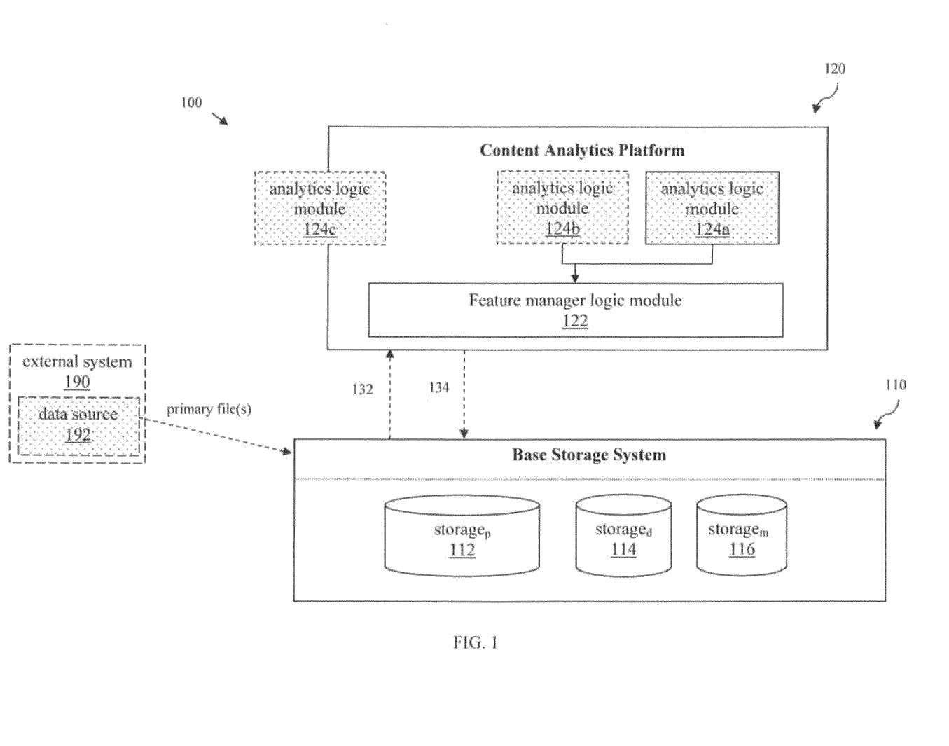

FIG. 1 is an illustration of a system in accordance with an embodiment of the invention. In FIG. 1, the system 100 includes a base storage system 110 and a content analytics platform 120. The base storage system 110 is coupled to an external system 190, which includes a data source 192, and also to the content analytics platform 120. Files from the data source 192 are transmitted to the base storage system 110 for storage.

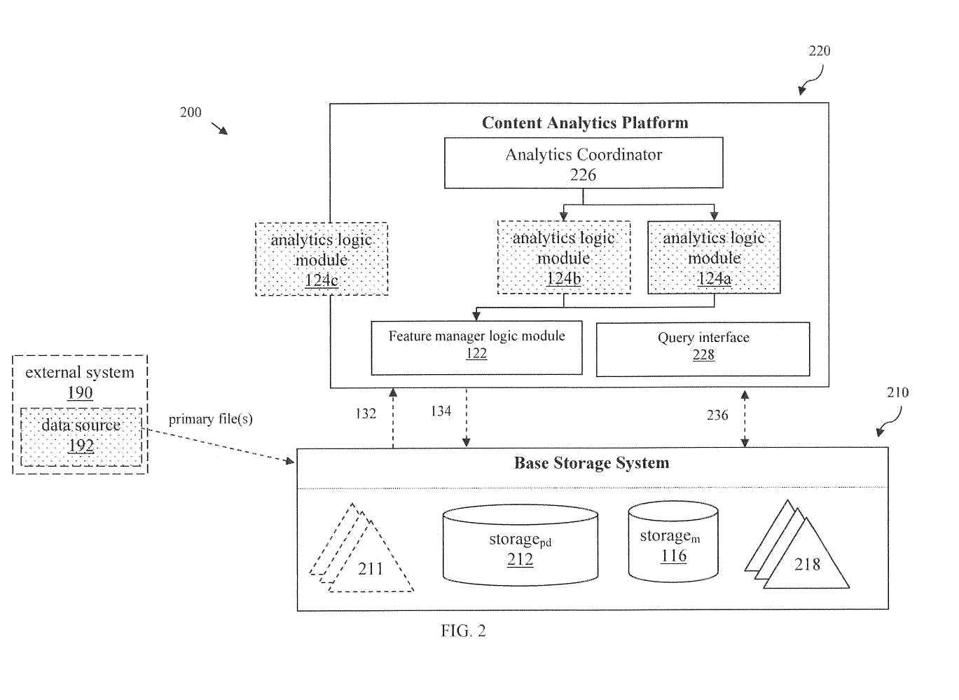

The base storage system 110 is configured to provide policy-based file management. In an exemplary embodiment, the base storage system 110 stores a plurality of primary files of differing modalities. The base storage system 110 includes a storageₚ 112, a storageₛ, 114, and a storageₘ 116. The storageₚ 112 is a repository that stores primary files, e.g., primary files of differing modalities. The storage_{d} 114 and the storageₘ 116 stores Features. The storage_{d} 114 is a repository that stores derived files. The storageₘ 116 stores metadata derived from content of primary files, e.g., in an index, list, array, or database structure. In FIG. 1, different storage units (e.g., 114 and 116) store Features of different types (e.g., derived files versus derived metadata). In other embodiments, a single storage unit stores Features of different types (e.g., both derived files and derived metadata). In FIG. 1, the primary files are stored on a different storage unit than the derived files (e.g., 112 and 114, respectively). In other embodiments, the primary files are stored on the same storage unit as the derived files, as shown in FIG. 2, which is discussed below.

The base storage system 110 is coupled to the content analytics platform 120. The content analytics platform 120 includes a Feature manager logic module 122 and a content analytics logic module 124a. The Feature manager logic module 122 is coupled to the content analytics logic module 124a. In certain embodiments, the content analytics platform 120 may include more than one content analytics logic module, e.g., 124a and 124b. In an exemplary embodiment, content analytics logic modules (e.g., 124a, 124b, and 124c) are each pluggable into the content platform. This is illustrated in FIG. 1 by showing content analytics logic module 124c, partially overlapping the content analytics platform. Content analytics logic module 124c may be plugged into the content analytics platform 120 in addition to or in place of content analytics logic module 124b, for example.

The content analytics logic module 124a is configured to create one or more Features derived from content of a primary file received from the external system 190. For example, a primary file received from the external system 190 may be transmitted to the content analytics platform 120 via path 132 for analysis. After the analysis is complete, the one or more Features created as a result may then be transmitted via path 134 back to the base storage system for storage. In an exemplary application, the one or more Features created include metadata derived from content of the primary file as well as a derived file based on the content of the primary file. The derived file may be smaller or larger in byte size than the primary file. In one embodiment, the metadata is created by one content analytics logic module (e.g., 124a) and the derived file is created by a different content analytics module (e.g., 124b). In another embodiment, the metadata and the derived file are created by the same content analytics module (e.g., 124a).

The Feature manager logic module 122 is configured to select an electronic storage policy for the primary file based on the one or more Features created by the content analytics logic module(s). In one embodiment, the Feature manager logic module 122 is also configured to link a Feature to the primary file from which the Feature was derived such that a storage policy for the primary file applies to the Feature.

In an exemplary embodiment, the data source 192 and analytics logic module(s) 124 are domain specific, as shown in the illustration by the dotted pattern. For example, if the data source 192 transmits primary files that include financial data, the analytics logic modules 124b may be used if it includes particular logic configured to perform financial analysis. If the system is implementing in a different environment, for example, in which the primary files transmitted by the data source are images produced by a machine that generates multimodal data (e.g., a machine used to generates multimodal neuroimages from magnetic resonance imaging (MRI) and/or from electroencephalography (EEG) scans), analytics logic modules 124c may be adapted into the system (e.g., in place of module 124b) if it includes particular logic configured to perform relevant content analysis (e.g., relevant image analysis).

FIG. 2 is another illustration of a system in accordance with an embodiment of the invention. In FIG. 2, the base storage system 210 includes the storageₘ 116, a storage_{pd} 212, an index 211 and an index 218. The storage_{pd} 212 stores both primary and derived files. The optional index 211 is an index of text from the primary file, and enables direct text searching of the primary files (e.g., of text-only primary files). The index 218 is an index created from the derived Features, and enables searching of the Features and/or primary files based on the derived Features.

In FIG. 2, the content analytics platform 220 includes the Feature manager logic module 122, the content analytics logic module 124a, an analytics coordinator 226, and a query interface 228. The analytics coordinator 226 is coupled to analytics logic modules included in the platform, and includes logic that coordinates between the various analytics logic module. The query interface 228 includes components to receive queries. For example, in one application a query for certain data is transmitted to the base storage system 210. The base storage system 210 communicates the query (as-is or transformed) to the content analytics platform 220. The query interface 228 in the content analytics platform 220 is configured to receive the query. In one application, the original query is for primary file(s), but the system 200 may transform that into a query over the Features or for information in one or more Features matching the original query. In response, if a result is found (e.g., by executing a search over the index 218 via path 236), the query interface 228 retrieves one or more Features (e.g., from storageₘ 116 and/or storage_{pd} 212). In one exemplary embodiment, the corresponding primary file(s) is/are also retrieved (e.g., from storage_{pd} 212) and included in the response to the query. In one embodiment, the original query is for Features, and the system is configured to also return primary file(s) under certain circumstances.

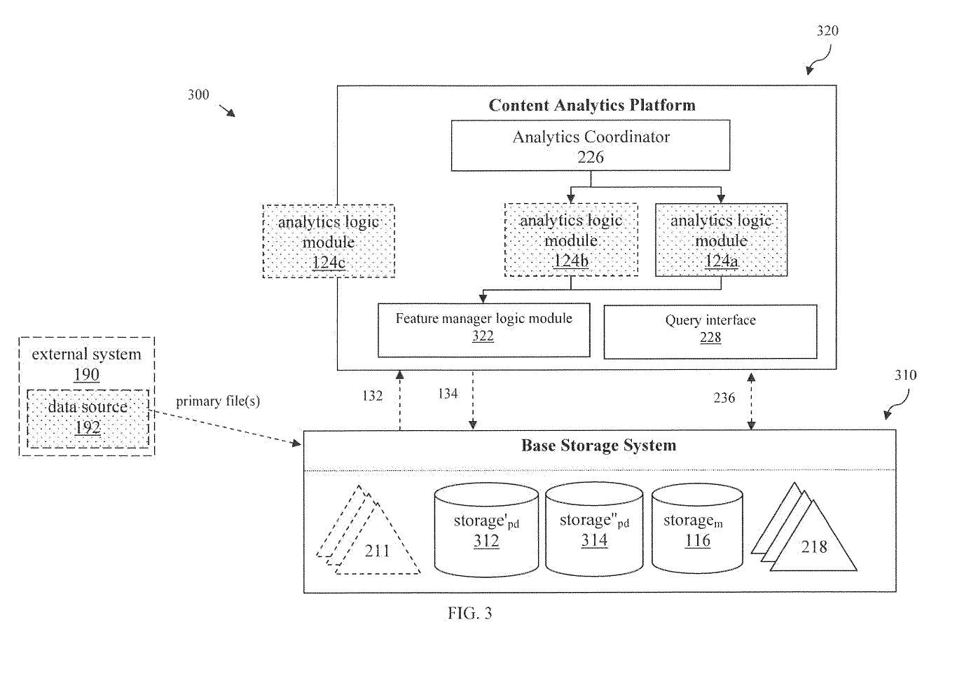

FIG. 3 is another illustration of a system in accordance with an embodiment of the invention. In FIG. 3, the system 300 includes a base storage system 310 which includes a first storage medium 312 and second storage medium 314. In the embodiment shown, both storage mediums store primary files and derived files, although in other embodiments, the storage of the primary files and derived files may be in different mediums. In FIG. 3, the storage medium 312 is labeled storage′_{pd} and the storage medium 314 is labeled storage″_{pd} to indicate that the storage media themselves differ. For example, storage′_{pd} may have different access characteristics than storage″_{pd}. For example, the speed of retrieval associated with storage′_{pd} may differ from the speed of retrieval associated with storage″_{pd}, e.g., if one of the storages is a near-line media and the other is tape. In one embodiment, storage′_{pd} is more expensive than storage″_{pd}. For example, storage′_{pd} may cost more per byte stored than storage″_{pd}. Currently, this may occur if storage′_{pd} is a hard disk drive (HDD) and storage″_{pd} is a tape drive, for example. In FIG. 3, the content analytics platform 320 includes a Feature manager logic module 322 that is configured to select between a storage policy identifying a first storage medium (e.g., 312) as a storage location for the primary file and a storage policy identifying a second storage medium (e.g., 314) as the storage location for the primary file based on the one or more Features derived from the content of the primary file. In one embodiment the selecting is between two distinct storage policies. In another embodiment, the selecting is between two options of a single storage policy.

As an example, when the embodiment shown in FIG. 3 is used in the application described above relating to neuroimages captured during a sleep study, the Feature manager logic module 322 is configured to select between a storage policy identifying storage′_{pd} as a storage location for the image and a storage policy identifying storage″_{pd} as the storage location for the image based on the one or more Features derived from the content of the primary file. If the study is more interested in brain activity during REM sleep than delta sleep, for example, and the Features indicates that the image is of brain activity during REM sleep, the Feature manager logic module 322 is configured to select between a storage policy identifying storage′_{pd} as a storage location for the image. The storage′_{pd} has access characteristics more desirable for purposes of the content. For example, the storage′_{pd} may be have faster access capabilities (e.g., because it is a solid state device instead of an optical device), may be designed for more frequent access, or is physically located closer to the client machines, etc. For the sleep study in this example, these access characteristics may be more important for handling images of brain activity during REM sleep than other brain activity (e.g., because the images will be accessed, analyzed, etc. more frequently). The storage″_{pd} has access characteristics more desirable for purposes of other content. For example, the storage″_{pd} may be designed for archival purposes, having slower access time, but the same or larger storage capacity for lower cost than storage′_{pd}.

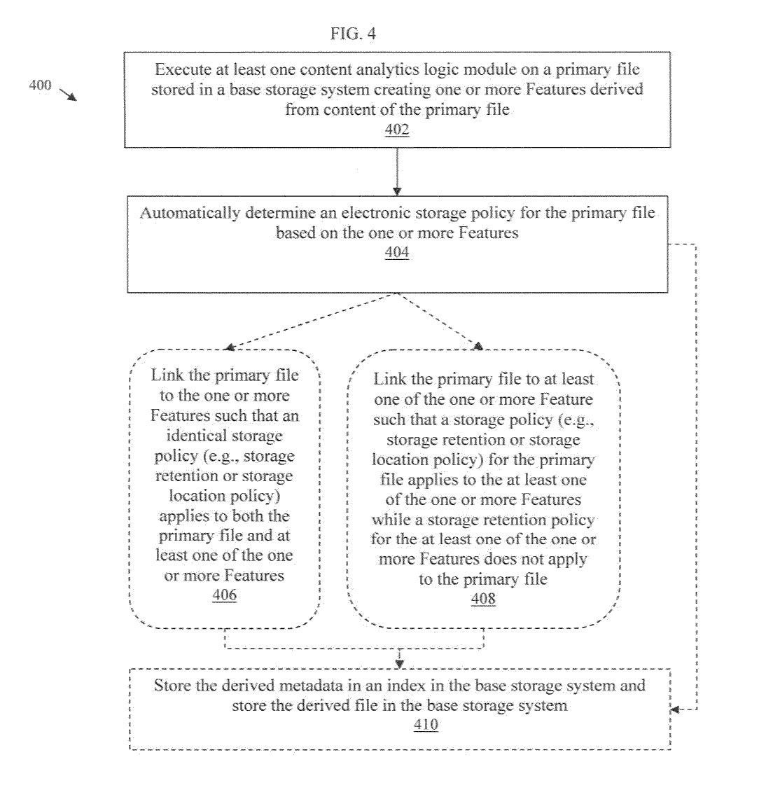

FIG. 4 is an illustration of a method in accordance with embodiments of the invention. At 402, at least one content analytics logic module (e.g., 124a, 124b, and/or 124c) is executed on a primary file stored in a base storage system. Executing the content analytics logic module(s) creates one or more Features (e.g., file(s) and/or metadata) derived from content of the primary file. The primary file is stored in the base storage system (e.g. 110, 210, or 310) by an external system (e.g., 190) coupled to the base storage system. In an exemplary embodiment, the primary file is one of a plurality of primary files of differing modalities stored in the base storage system.

At 404, an electronic storage policy is automatically determined for the primary file based on the one or more Features. The automatically determined policy may control the lifecycle of the files stored in the base storage system. For example, based on the Feature(s), the automatically determined policy may instruct the system to store the primary file in a certain repository in the base storage system. Different repositories may be stored on different storage media (e.g., in a tape drive instead of in a hard drive), and different storage media may retain files for different lengths of time, have different back-up schedules, or have different security restrictions. Different repositories are also often separately indexed.

In an exemplary embodiment, the method 400 includes 406. At 406, the primary file is linked to the one or more Features such that an identical storage policy applies to both the primary file and at least one of the one or more Features. For example, in one application, the primary file is an MRI image of a brain and, from content of the image, an analytics module (e.g., 124a) creates a derived file that is a close-up of a particular section of the MRI image, and metadata identifying a clinical categorization of an artifact on which the close-up image is focused. At 406, the MRI image is linked to the close-up image and the metadata such that an identical storage retention policy applies to both the MRI image and at least one of the Features (e.g., the close-up image). In one embodiment, the identical storage retention policy triggers automatic deletion of the primary file and at least one of the one or more Features after expiration of an audit-based retention period. In the current example, an identical storage retention policy may trigger automatic deletion of the MRI and the close-up image after an audit-based retention period based on a patient privacy policy, for example.

As another example, in one application, the primary file is a file containing raw financial data and, from content of the raw financial data, an analytics module creates a derived file (e.g., a summary report of the raw financial data). At 406, the file containing the raw financial data is linked to the report such that that an identical storage retention policy applies to both the raw data file and report. In the current example, the identical storage retention policy triggers automatic deletion of the raw data file and the report after expiration of an audit-based retention period (e.g., based on regulations concerning financial data). Accordingly, in certain embodiments, a primary file and any Features derived from content the primary file (e.g., any derived metadata or derived files) are deleted from the storing repository/repositories, when the retention period for the primary file expires. In most embodiments in which the primary file and any Features derived from content of the primary file share a storage policy, changes to the policy for the primary file will also affect Feature(s) sharing that policy.

In certain embodiments, the method 400 includes 408. At 408, the primary file is linked to at least one of the one or more Feature such that a storage policy for the primary file applies to at least one of the one or more Features while a storage policy for the at least one of the one or more Features does not apply to the primary file. For example, in the example above in which the primary file is the raw financial data file, and the derived file is a summary report of the raw financial data, at 408, the raw financial data file may be linked to the report such that a storage retention policy for the raw financial data file applies to the report while a storage retention policy for the report does not apply to the raw financial data file. For example, if the raw financial data file must be retained for seven years, that retention policy will apply to both the raw financial data file and the report. However, the report may have a retention policy of three years, which applies only to the report. So, for instance, if the financial data file is six years old, and new financial analytics is developed and applied to the financial data file with a new content analytics logic module to create a new report this year, the financial data file and the new report are linked such that when the financial data file is deleted one year from now (after the seven year mark is reached), the report is also deleted. Thus, the storage retention policy for the primary file (e.g., the financial data file) triggers automatic deletion of the primary file and at least one of the one or more Features (e.g., the report) after expiration of an audit-based retention period. In one embodiment, the system executes this by comparing the retention policies for the primary and any Features and selects a most restrictive retention policy, using the retention policy of the primary file for the Feature, thus overriding the retention policy of a Feature.

In the application above, if the financial data file is instead created this year, and the report is generated the same year, the financial data file and the report are linked such that the storage retention policy of the report (in this example, deletion in three years) does not apply to the financial data file. Rather, the report will be deleted in three years time, and the financial data file would be retained for an additional four years beyond retention of the report, for the full seven years. In this situation, a most restrictive retention policy is not used to override the policy of the primary file.

The storage policy may also cause the primary file to be stored in a different location from the derived file. For example, the raw financial data file may be stored in an off-line or near-line repository, while the summary report is stored in a near-line or online repository, respectively.

By executing content analytics on the primary file, and linking the primary file and Features derived from content of the primary file in an automated fashion as done in embodiments of this invention, complex policies can be automatically administered in a smart manner. This can be useful in situations in which the number of files being administered is large, when the size of the files makes one-size fits all storage management of a repository financially costly, and/or particularly when the policies are being driven by strict (and often complex) rules and regulations based on file content, for example.

In one embodiment, creating the one or more Features derived from content of the primary file at 402 includes creating metadata derived from the content of the primary file, creating a derived file having content based on the content of the primary file, and determining a storage policy for the primary file and the derived file based on the derived metadata. For example, in one application, a primary file is an audio transcript. Content analytics are applied to the primary file to create metadata and an audio clip of, for example, the first thirty seconds of the audio transcript. The content analytics logic used to analyze the file and create the metadata may be capable of, for example, analyzing the audio and determining the language used of the audio recording, or the identity of the person whose voice is recorded. Embodiments of the invention determine a storage policy for the audio transcript and the audio clip based on the metadata. The storage policy may, for example, trigger storage of the audio file and audio clip in one repository of the base storage system if the metadata indicates that the language of the audio transcript was English, this repository being accessible by a software application designed for English speakers. The storage policy may trigger storage of the audio file and audio clip in a different repository of the same base storage system if the metadata indicates that the language of the audio transcript was Spanish, this repository being accessible by a software application designed for Spanish speakers. As another example, the storage policy may trigger the storage (which may be or include replication) of the audio file and audio clip in a repository located in France if the metadata indicates that the language of the audio transcript was French, and in Germany if the metadata indicates that the language of the audio transcript was German, for example. As another example, the storage policy may trigger the storage of the audio file and audio clip in a repository having a longer retention period if the identity of the person whose voice is recorded is a public figure, e.g., when the audio recording is of a speech given by the President of the United States, and a repository having a shorter retention period if the identity of the person whose voice is recorded is unknown. In one embodiment, the audio clip is smaller in byte size than the primary file (e.g., because it a truncated version of the audio transcript). In other embodiments, the audio clip is the same or larger in byte size than the primary file (e.g., if the audio clip is in .wav format and the audio transcript is in .mp3 format).

As another example, in one application, the primary file is a company's internal copy of a filed patent application and, from content of the application, an analytics module creates a derived file (e.g., a dossier containing information such as title, filing date, inventors, serial number, etc.). A content analytics module (e.g., 124c) may create derived metadata. This may occur, for example, by analyzing content of the application or the derived file (e.g., to extract a serial number), communicating with an external system to retrieve the current status of the application, and creating metadata indicating the current status of the application. Embodiments of the invention determine a storage policy for the internal copy of the application and the dossier based on the metadata. For example, if the metadata derived from content analytics indicates that the current status of the application is issued or divested, the storage policy may indicate that the internal copy of the application can be deleted while the dossier should be maintained for another N number of years. This may result in significant storage space savings in this situation since the primary file is likely much larger in byte size than the derived file.

It should be readily understood that in certain embodiments, Features derived from content of a primary file may change over time. For example, the metadata indicating the status of the patent application may change over time and it may not be useful to retain that older metadata. Thus, a storage policy determined for a Feature (e.g., the derived metadata) may differ from the storage policy determined for the primary file and/or another Feature (e.g., a derived file). The storage policy for the metadata may allow for the deletion of the metadata without deletion of the derived file and/or primary file, for example.

In certain embodiments, the method 400 includes 410. At 410, the derived metadata created at 402 is stored in an index (e.g., 218) in the base storage system, and the derived file is stored in the base storage system (e.g., in 114, 212, 312, or 314).

As discussed above, in certain embodiments, creating the one or more Features at 402 includes creating metadata derived from the content of a primary file. In one embodiment, the primary file is an image produced by a machine that generates multi-modal data and the derived metadata represents a categorization of content in the image. For example, the machine that generates the multimodal data may be medical diagnosis equipment and the derived metadata may represent a clinical categorization of content in the image. The clinical categorization may be determined based on analyzing the content of the multimodal data and identifying an artifact in the image, for example.

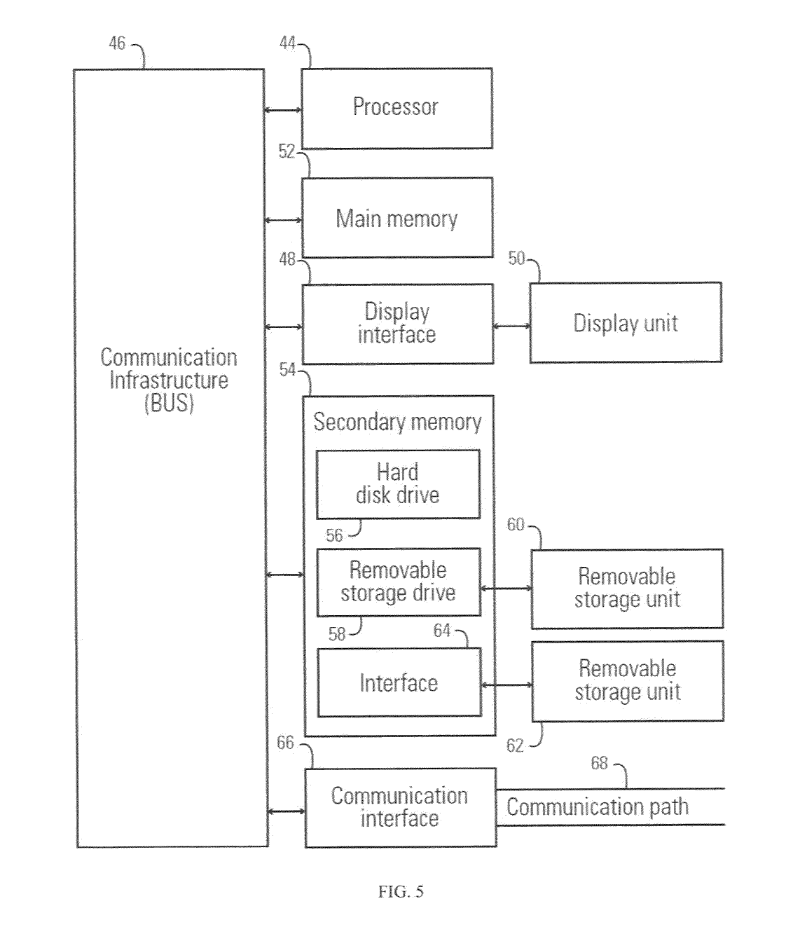

FIG. 5 is a high level block diagram showing an information processing system useful for implementing embodiments of the invention. The computer system includes one or more processors, such as processor 44. The processor 44 is connected to a communication infrastructure 46 (e.g., a communications bus, cross-over bar, or network). Various embodiments are described in terms of this exemplary computer system. After reading this description, it will become apparent to a person of ordinary skill in the relevant art(s) how to implement embodiments of the invention using other computer systems and/or computer architectures.

The computer system can include a display interface 48 that forwards graphics, text, and other data from the communication infrastructure 46 (or from a frame buffer not shown) for display on a display unit 50. The computer system also includes a main memory 52, preferably random access memory (RAM), and may also include a secondary memory 54. The secondary memory 54 may include, for example, a hard disk drive 56 and/or a removable storage drive 58, representing, for example, a floppy disk drive, a magnetic tape drive, or an optical disk drive. The removable storage drive 58 reads from and/or writes to a removable storage unit 60 in a manner well known to those having ordinary skill in the art. Removable storage unit 60 represents, for example, a floppy disk, a compact disc, a magnetic tape, or an optical disk, etc. which is read by and written to by removable storage drive 58. As will be appreciated, the removable storage unit 60 includes a computer readable medium having stored therein computer software and/or data.

In alternative embodiments, the secondary memory 54 may include other similar means for allowing computer programs or other instructions to be loaded into the computer system. Such means may include, for example, a removable storage unit 62 and an interface 64. Examples of such means may include a program cartridge and cartridge interface (such as that found in video game devices), a removable memory chip (such as an EPROM, or PROM) and associated socket, and other removable storage units 62 and interfaces 64 which allow software and data to be transferred from the removable storage unit 62 to the computer system.

The computer system may also include a communications interface 66. Communications interface 66 allows software and data to be transferred between the computer system and external devices. Examples of communications interface 66 may include a modem, a network interface (such as an Ethernet card), a communications port, or a PCMCIA slot and card, etc. Software and data transferred via communications interface 66 are in the form of signals which may be, for example, electronic, electromagnetic, optical, or other signals capable of being received by communications interface 66. These signals are provided to communications interface 66 via a communications path (i.e., channel) 68. This channel 68 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 52 and secondary memory 54, removable storage drive 58, and a hard disk installed in hard disk drive 56.

Computer programs (also called computer control logic) are stored in main memory 52 and/or secondary memory 54. Computer programs may also be received via communications interface 66. Such computer programs, when executed, enable the computer system to perform the features of the present invention as discussed herein. In particular, the computer programs, when executed, enable the processor 44 to perform the features of the computer system. Accordingly, such computer programs represent controllers of the computer system.

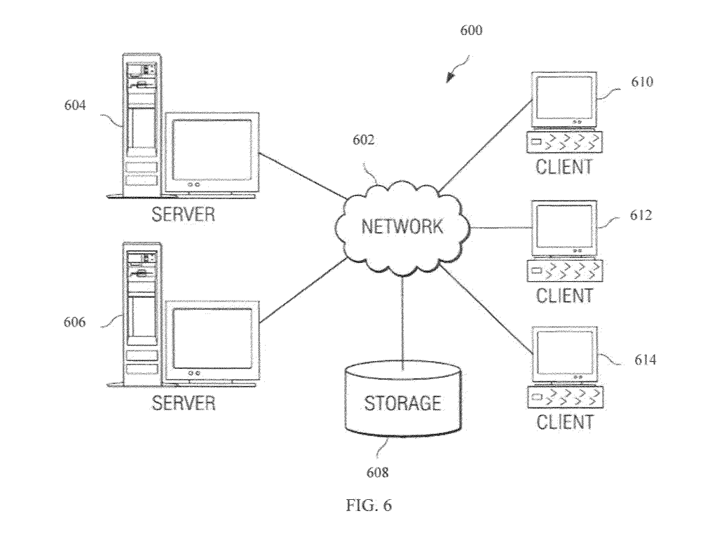

FIG. 6 represents an exemplary distributed data processing system in which aspects of the illustrative embodiments may be implemented. Distributed data processing system 600 may include a network of computers in which aspects of the illustrative embodiments may be implemented. The distributed data processing system 600 contains at least one network 602, which is the medium used to provide communication links between various devices and computers connected together within distributed data processing system 600. The network 602 may include connections, such as wire, wireless communication links, or fiber optic cables.

In the depicted example, server 604 and server 606 are connected to network 602 along with storage unit 608. In addition, clients 610, 612, and 614 are also connected to network 602. These clients 610, 612, and 614 may be, for example, personal computers, network computers, or the like. In the depicted example, server 604 provides data, such as boot files, operating system images, and applications to clients 610, 612, and 614. Clients 610, 612, and 614 are clients to server 604 in the depicted example. Distributed data processing system 600 may include additional servers, clients, and other devices not shown.

In the depicted example, distributed data processing system 600 is the Internet with network 602 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 600 may also be implemented to include a number of different types of networks, such as for example, an intranet, a local area network (LAN), a wide area network (WAN), or the like. As stated above, FIG. 6 is intended as an example, not as an architectural limitation for different embodiments of the present invention, and therefore, the particular elements shown in FIG. 6 should not be considered limiting with regard to the environments in which the illustrative embodiments of the present invention may be implemented.

Thus, generating Features using information derived from content of a primary file, and optimizing storage of primary files, and in certain instances of Features, stored in a policy-based storage system, such as a multimodal file repository, using the information derived from content of the primary file(s) is disclosed. As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, references to “a method” or “an embodiment” throughout are not intended to mean the same method or same embodiment, unless the context clearly indicates otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method of managing storage of electronic files using information derived from content of the electronic files, wherein the electronic files are stored in a computer storage system having policy-based electronic file storage management, the method comprising:
executing at least one content analytics logic module on a primary file stored in a base storage system to create one or more Features derived from content of the primary file, wherein the primary file is stored in the base storage system by an external system coupled to the base storage system; and
automatically determining an electronic storage policy for the primary file based on the one or more Features.

2. The method of claim 1, further comprising:
linking the primary file to the one or more Features such that an identical storage retention policy applies to both the primary file and at least one of the one or more Features.

3. The method of claim 2, wherein the identical storage retention policy triggers automatic deletion of the primary file and at least one of the one or more Features after expiration of an audit-based retention period.

4. The method of claim 1, further comprising:
linking the primary file to at least one of the one or more Feature such that a storage retention policy for the primary file applies to the at least one of the one or more Features while a storage retention policy for the at least one of the one or more Features does not apply to the primary file.

5. The method of claim 4, wherein the storage retention policy for the primary file triggers automatic deletion of the primary file and at least one of the one or more Features after expiration of an audit-based retention period.

6. The method of claim 1, wherein creating one or more Features derived from content of the primary file comprises:
creating a first Feature, wherein the first Feature is metadata derived from the content of the primary file; and
creating a second Feature, wherein the second Feature is a derived file, and content of the derived file is based on the content of the primary file, and wherein the method further comprises:
determining a storage policy for the primary file and the derived file based on the derived metadata.

7. The method of claim 1, further comprising:
storing the derived metadata in an index in the base storage system; and
storing the derived file in the base storage system.

8. The method of claim 1, wherein creating one or more Features derived from content of the primary file comprises:
creating metadata derived from the content of the primary file.

9. The method of claim 8, wherein the primary file is an image produced by a machine that generates multi-modal data and the derived metadata represents a categorization of content in the image.

10. The method of claim 1, wherein the primary file is one of a plurality of primary files of differing modalities stored in the base computer storage system.

11. The method of claim 1, further comprising:
automatically determining an electronic storage policy for at least one of the one or more Features based on the electronic storage policy automatically determined for the primary file.

12. A system comprising:
a base storage system coupled to an external system, the base storage system to store a plurality of primary files of differing modalities, wherein one of the plurality of primary files is a primary file received from the external system, and wherein the base storage system is configured to provide policy-based file management; and
a content analytics platform coupled to the base storage system, the content analytics platform comprising:
a content analytics logic module plugged into the content analytics platform and configured to create one or more Features derived from content of the primary file received from the external system; and
an Feature manager logic module coupled to the plugged-in content analytics logic module and configured to select an electronic storage policy for the primary file based on the one or more Features and to link the one or more Features to the primary file such that a storage policy for the primary file applies to the one or more Features.

13. The system of claim 12, wherein the one or more Features includes a first Feature and a second Feature, wherein the first Feature is metadata derived from content of the primary file and the second Feature is a derived file, wherein the derived file is smaller in byte size than the primary file and content of the derived file is based on the content of the primary file.

14. The system of claim 12, wherein the one or more Features includes a first Feature, wherein the first Feature is metadata derived from content of the primary file, and the system further comprises:
a second content analytics logic module plugged into the content analytics platform and coupled to the Feature manager, the second content analytics logic module configured create a second Feature, wherein the second Feature is a derived file, and wherein the derived file is smaller in byte size than the primary file and content of the derived file is based on the content of the primary file.

15. The system of claim 12, wherein the content analytics platform further comprises:
a query interface configured to receive a query for Features and, in response, retrieve one or more Features and corresponding primary files based on the query.

16. The system of claim 12, wherein the base storage system comprises:
a first storage medium; and
a second storage medium,
wherein the first storage medium is more expensive than the second storage medium, and
wherein the Feature manager logic module is configured to select between a first electronic storage policy identifying the first storage medium as a storage location for the primary file and a second electronic storage policy identifying the second storage medium as the storage location for the primary file based on the one or more Features derived from the content of the primary file.

17. A computer program product for policy-based computer file life-cycle management based on content-based analytics, the computer program product comprising:
a computer usable storage medium having computer usable program code embodied therewith, the computer usable program code comprising:
computer usable program code configured to execute at least one content analytics logic module on a primary file stored in a base storage system creating one or more Features derived from content of the primary file, wherein the primary file is stored in the base storage system by an external system coupled to the base storage system; and
computer usable program code configured to automatically determine an electronic storage policy for the primary file based on the one or more Features.

18. The computer program product of claim 17, wherein the computer usable program code further comprises:
computer usable program code configured to link the primary file to at least one of the one or more Features such that a storage retention policy for the primary file that triggers automatic deletion of the primary file also triggers automatic deletion of the at least one of the one or more Features after expiration of an audit-based retention period.

19. The computer program product of claim 17, wherein the computer usable program code further comprises:
computer usable program code configured to automatically determine a first storage medium for the primary file when the one or more Features indicates a first categorization of the primary file content and a second storage medium for the primary file when the one or more Features indicates a second categorization of the primary file content.

20. The computer program product of claim 17, wherein the computer usable program code further comprises:
computer usable program code configured to determine a storage policy for one of the Features based on another one of the Features.
